(19) United States
(12) Patent Application Publication
(10) Pub. No.: US 2006/0134525 A1
(43) Pub. Date: Jun. 22, 2006

(54) Rechargeable lithium battery

(76) Inventors: Christian Kleijnen, Ell (NL); Adam Best, Delft (NL); Michel Saakes, Apeldoorn (NL)

Correspondence Address: YOUNG & THOMPSON, 745 SOUTH 23RD STREET, 2ND FLOOR, ARLINGTON, VA, 22202, US

(21) Appl. No.: 10/529,391

(22) PCT Filed: Sep. 26, 2003
(86) PCT No.: PCT/NL03/00659

§ 371 Date: Oct. 28, 2005

(30) Foreign Application Priority Data
Sep. 27, 2002 (NL) 1021552
Mar. 31, 2003 (NL) 1023054
Apr. 4, 2003 (NL) 1023112

(51) Int. Cl. H01M 2/16; H01M 10/40; H01M 10/36

(52) U.S. Cl. 429/249; 29/623.5; 429/319; 429/251; 429/252; 429/254; 429/324

(57) ABSTRACT

The invention relates to a rechargeable battery based on lithium metal as anode. The rechargeable lithium metal battery according to the invention comprises an electrolyte and also chlorine and fluorine containing compounds: The battery according to the invention has, in particular, a strongly improved Coulomb efficiency of the metallic lithium. In addition, due to gel formation, a much safer system is formed than with liquid electrolyte.

The invention relates to rechargeable batteries based on lithium metal as anode.

In contrast with Li-ion batteries, rechargeable Li-metal batteries, with a few exceptions, have never been commercially applied on a large scale, in spite of considerable research efforts (for an overview see: Aurbach et al. in Solid State Ionics 148 (2002) 405-416).

To arrive at a rechargeable lithium metal battery with a highest possible specific energy, it is necessary to use electrochemical couples having, on the one hand, a largest possible difference in redox potential and, on the other hand, a highest possible specific capacity. Examples of redox couples for the cathode (positive electrode) are Mn⁴⁺/Mn³⁺ (for instance in the form of MnO₂/LiMnO₂), Co⁴⁺/Co³⁺ (for instance in the form of CoO₂/LiCoO₂), Ni⁴⁺/Ni³⁺ (for instance in the form of NiO₂/LiNiO₂). As an anode (negative electrode), for instance, LiₓC/C, Li⁺/Li can be used. In addition to a highest possible specific capacity for the cathode (in the order of 160-200 mAh/g), the specific capacity of the anode is important. For the anode, the differences are considerable: for LiₓC/C, the specific capacity with x=6 for graphite equals 372 mAh/g, whereas for Li, a specific capacity of 3840 mAh/g holds. The use of metallic lithium as an anode is therefore quite obvious were it not that lithium metal gives a high degree of reactivity with the electrolyte present, leading to a limited cycling life. However, to arrive at a rechargeable lithium battery with a very high specific energy, the use of lithium metal is very attractive. To obtain the desired cycling life with lithium metal as an anode, it is necessary to stabilize the lithium/electrolyte interface, such that the reactivity of the lithium is strongly reduced. However, the lithium metal present should not undergo complete passivation because then a high discharge current density is no longer possible. For over thirty years now, the formation of a stable interfacial layer between lithium and the electrolyte has been a subject of research. The object here is to arrive at a rechargeable lithium metal battery with a high energy density (Wh/l) and high specific energy (Wh/kg). The rechargeable lithium metal battery is precisely the type where no definitive breakthrough has been achieved with regard to commercialization. The reason for that is that rechargeable lithium metal batteries, in contrast with so-called Li-ion batteries, have a limited cycling life (the number of times that charging and discharging can take place) and, in addition, a relatively long charge time (C/10, that is, a charge time of 10 hours) compared to Li-ion (1-2 hours). Known rechargeable lithium metal batteries (developed by Tadiran Ltd., Israel) have a cycling life of 350 cycles with a charge time used of 10 hours (C/10 hours). An excess of lithium (factor 4.5) is then utilized for compensating the loss of Li per cycle. At the C/10 charge rate used (charge current density is 0.4 mA/cm²), the Coulomb efficiency of the lithium equals 99.5%. The electrolyte which is used in these known batteries consists of 1,3-dioxolane and lithium hexafluoroarsenate (LiAsF₆) with tributyl amine (TBA) as stabilizer. Until now, this electrolyte yields the best results in terms of cycling life (highest values for the Coulomb efficiency) and safety (intrinsically safe because the solvent polymerizes upon excessive charging, so that in that case resistance increases and hence the current decreases).

It is supposed that the reason that this electrolyte (based on LiAsF₆ in 1,3-dioxolane) functions well resides in the formation of a reaction product of 1,3-dioxolane forming a sort of plastic interfacial layer on the lithium/electrolyte interface. Moreover, this interfacial layer is a good Li⁺ ion conductor. Despite these excellent properties of the LiAsF₆/1,3-dioxolane electrolyte, it has not appeared possible with this electrolyte or with other electrolytes to develop a rechargeable lithium metal battery suitable for fast charging (<C/2, i.e. a charge time of at most 2 hours) and having a sufficiently long cycling life (of, for instance, at least 500 cycles).

The object of the invention is to provide a rechargeable lithium metal battery which does not have the above-mentioned drawbacks, in other words, a battery suitable for rapid charging and which has a sufficiently long cycling life.

It has been found that this object can be achieved by using chlorine- and optionally fluorine-containing compounds in lithium metal batteries. Preferably, the chlorine and, optionally, fluorine functions are introduced into the batteries as polymeric materials, preferably arranged as separator or in an arrangement whereby these polymeric materials have been impregnated into a separator or have been coated onto one or both sides of the separator, while the separator can be made of a different polymer, for instance of polyolefins such as polyethylene or polypropylene. Accordingly, the present invention relates to a rechargeable lithium metal battery in which a separator is used, comprising at least one chlorinated polymer and optionally a fluorinated polymer.

Preferably, the chlorine containing polymers comprise monopolymers, copolymers and terpolymers, i.e. polymers based on one, two or three different monomers, respectively, while each time, at least one type of monomer is chlorinated (i.e. contains one or more chlorine atoms).

Preferably, the fluorine containing polymers, too, comprise monopolymers, copolymers and terpolymers, while, each time, at least one type of monomer is fluorinated (i.e. contains one or more fluorine atoms).

A polymer with both chlorinated and fluorinated groups can also be used.

Therefore, the chlorine and, if desired, fluorine functions can be accommodated in one and the same polymer (mono, copolymers or terpolymer). Preferably, a terpolymer comprising chlorinated and fluorinated groups is used.

Highly suitable are polymers, preferably terpolymers, based on monomers selected from chlorinated and/or fluorinated olefins, preferably chlorinated and/or fluorinated vinylidene, propylene and/or ethylene.

A suitable terpolymer is VDF-HFP-CTFE poly(vinilydene fluoride-hexafluoropropylene-chlorotrifluoroethylene). Specifically the VDF-HFP-CTFE terpolymers described in WO-A-02/10233 are suitable for use in the present invention. The mutual ratios of the monomers can vary. A typical composition contains 73.6 wt. % of VDF, 4.9 wt. % of HFP and 21.5 wt. % of CTFE.

Preferably, the battery according to the invention comprises a separator (preferably based on one or more polyolefins) which separates the lithium electrode from the other electrode, while the chlorine and, if desired, fluorine containing polymers have been applied as a coating on at least one side of the separator, such that a coated side adjoins the lithium metal. According to a different embodiment, this separator is impregnated with these chlorine- and optionally fluorine-containing polymeric compounds.

Typically, the separator is a (micro)porous structure preventing electronic short circuiting. The separator's pore structure can be, for instance, one or two dimensional. In one embodiment, the separator is built up from a microporous structure based on polyolefins such as, for instance, polyethylene or polypropylene. Especially preferred is the use of chlorine and fluorine containing polymers as separator. In order to obtain the required mechanical strength, in this case, the chlorine and fluorine containing polymers can be cross-linked. In this manner, the function of gel forming layer and the improvement of the Coulomb efficiency of the lithium anode are combined in the separator according to the invention. The chemical cross-linking improves the mechanical properties for protection against lithium metal dendrites. If desired, the mechanical properties (in particular the strength) of the coating and of the cross-linked system can be further improved by including therein electrochemically inert nanomaterials (i.e. fine particles of magnitudes in the order of nanometers, for instance 1-10 nm). Suitable particles are silica. (SiO₂) or other ceramic materials. Alumina (Al₂O₃) is also highly suitable. An additional advantage of alumina is that it is hygroscopic so that any water present can be captured.

As a measure for the behavior of rechargeable batteries upon fast charging, the Coulomb efficiency can be used. What is meant by Coulomb efficiency is the ratio of the discharge capacity and the charge capacity for a cycle i, assuming that for the determination thereof use has been made of a limiting amount of lithium metal, that is, the capacity of the lithium anode is less than the capacity of the cathode (in this case, for instance, Li_{0.33}MnO₂ in charged condition).

For accurately determining the Coulomb efficiency of the lithium metal/electrolyte interface, two independent measurements are to be carried out in, respectively:
1. a system built up from an excess of lithium as anode, a separator with electrolyte and a cathode of limiting capacity (a capacity determining cathode)
2. a system built up from a limiting amount of lithium as anode, a separator with electrolyte and a cathode of excess capacity (a capacity determining anode).

With the number of charge/discharge cycles as a variable, a cell built up from, for instance, Li (200 μm)/electrolyte/Li_{0.33}MnO₂, is charged and discharged with a set charge/discharge current density to a preset charge voltage (3.5V) and discharge voltage (2.0V).

In case of an excess of Li, the ratio of the discharge capacity and the charge capacity corresponds to the Coulomb efficiency of the cathode, since loss of the anode is compensated by the excess of lithium that is present. The Coulomb efficiency of the cathode is called eta-cathode.

With the number of charge/discharge cycles as a variable, a cell built up from a limiting amount of lithium (Li-coating on Cu)/electrolyte/Li_{0.33}MnO2 is charged and discharged with a set charge/discharge current density to a preset charge voltage (3.5V) and discharge voltage (2.0V). This build-up is such that, in discharged condition, the battery contains no or no appreciable amount of metallic lithium (for instance, less than 1 wt. % of all the lithium is still metallic), since all lithium metal is stored in the cathode as Li-ion. In that case, the cathode comprises an intercalation compound, in this case lithium manganese dioxide. This is of importance because the release of metallic lithium when the battery is being processed in discharged condition can be prevented. This simplifies the processing of batteries according to the invention at the end of their useful life.

In case of a limiting amount of lithium, the ratio of the discharge capacity and the charge capacity corresponds to the Coulomb efficiency of the lithium anode. The Coulomb efficiency of the anode is called eta-anode.

If a cell with a limiting amount of lithium is charged and discharged, the ratio of the charge and discharge capacity (Coulomb efficiency for a cycle i) equals eta-cycle.

The value of eta-cycle equals the product of eta-anode and eta-cathode. This means that eta-cathode must be determined separately. In the case of a Li_{0.33}MnO₂ cathode, using 1 M LiAsF₆ in 1,3-dioxolane as electrolyte, PTFE as binder, carbon black Super P as electronic conductor and Al-mesh, the measured value of eta-cathode equaled 99.6%. Since the measuring error was 0.3%, the value of eta-cathode is virtually equal to 100%, which corresponds to measuring values for cylindrical cells with Li_{0.33}MnO₂ as cathode.

The Coulomb efficiency of the anode, in case of a limiting amount of lithium, can only be determined if a very thin layer of some micrometers of lithium is used. Since such a thin layer of lithium is very vulnerable and not manageable, preferably, a plating of lithium on etched copper is selected as substrate. The copper layer is then, for instance, 25 μm thick. The plating bath used for lithium then consists of, for instance, 1 M LiAsF₆ in 1,3-dioxolane. A suitable current density in the plating is 0.5 mA/cm². The lithium that was precipitated consisted of a very level layer. After deposition, the lithium can be rinsed in 1,3-dioxolane.

For accurately determining the values of eta-cathode and eta-anode, it is important that the cells used (for instance coin cells 20/32, i.e. with a diameter of 20 mm and a thickness of 3.2 mm) are built up and tested under the proper conditions. These preconditions are known to the skilled person and comprise inter alia a proper pressure in the cell, a required amount of electrolyte, a correct positioning of the electrodes such that the lithium electrode experiences a uniform pressure and that the cathode has the required contact with the housing, the proper morphology of the lithium layer applied onto the copper substrate, the choice of the proper type of polyolefin separator, a properly performed coating or impregnating procedure for terpolymer applied on the separator, a proper pretreatment of the cell after assembly of the cell and prior to charging and discharging, a controlled temperature for charging and discharging, a correct charge and discharge current density and charge and discharge voltage and the proper type of binder for the cathode. Suitable values for these factors can be determined per case by the skilled person in a simple manner.

The batteries according to the invention yield an improvement in particular with regard to the above-outlined problems upon fast charging, in particular an improvement of the Coulomb efficiency of the lithium plating (deposition of lithium metal).

For a conventional battery with an electrolyte comprising 1 M LiAsF₆ in 1,3-dioxolane and stabilized with tributyl amine, when a limiting amount of lithium is used, as measured in a 20/32 coin cell built up in the configuration suitable therefor, a Coulomb efficiency of 97.0% is measured at a charge current density of 0.7 mA/cm² and a discharge current density of 0.3 mA/cm². This means that for each cycle, a loss of 3% of the capacity of the lithium anode occurs. Even when a factor 4 excess of lithium is used, this leads to a limited number of cycles, assuming that one stops at 80% of the initial discharge capacity of the lithium metal battery: the number of cycles attained is 53.

The reason for the low Coulomb efficiency of conventional cells resides in the rapid charging (high charge current density). It is assumed that upon rapid charging of the conventional systems, the reactivity of the lithium increases as a result of the increase of the surface (with rapid charging, there is no longer a level deposition, but a deposition with needle-shaped lithium crystals (dendrites) as a result of which the specific surface of the lithium increases). Since lithium metal reacts with the electrolyte to form reaction products, an exhaustion of the electrolyte present occurs, so that the cell is no longer entirely wetted and no longer functions properly.

The Coulomb efficiency can be changed by selecting a different configuration. For instance, in a cyclindrical cell, with a charge current density of 0.4 mA/cm² and a factor 4.5 excess of lithium, the Coulomb efficiency of the lithium deposition equals 99.5%. In this case, the charge current density of 0.4 mA/cm² corresponds to a charge time of C/10, that is, a charge time of 10 hours. However, this charge time (10 hours) is too long to be eligible for commercialization for mobile phones etc. (charge time at most 2 hours). The connection between the charge time and the charge current density is determined by the structure of the battery, in particular the capacity per surface, expressed in MAh/cm². This means that the charge time is defined by the loading of the surface (the current collector) with the active material. Starting from, for instance, a cathode loading of 8 mAh/cm² and a charge time of C/10 (10 hours), the charge current density is 0.8 mA/cm². The actual charge current density is lower by a half because on both sides of the cathode, an anode (of lithium metal) is arranged so that the C/10 charge current density equals 0.4 mA/cm². Therefore, the exposed surface is twice the geometric surface of the electrode.

However, increasing the electrode surface, for the purpose of lowering the charge current density and hence improving the Coulomb efficiency, is subject to limitations because an increasingly thinning active layer leads to an increasingly larger share in the weight of the current collector, so that the ratio of the weight of the active material and the current collector decreases and hence becomes more unfavorable. As a result, the specific energy (Wh/kg) and the energy density (W/l) decrease. To arrive at a rapidly rechargeable lithium metal battery which has both a high specific energy and the required number of cycles upon rapid charging, it is necessary to utilize electrodes with a relatively high loading while the charging efficiency (Coulomb efficiency) must be higher than for the conventional rechargeable lithium metal batteries. If we start from sufficiently thin electrodes with a high density, an improvement of the conventional batteries is desired at an applied current density of 0.7 mA/cm².

According to the invention, a higher charging efficiency is obtained in the case where a limiting amount of lithium is used and when rapid charging is initiated. Rapid charging is understood to mean a charge current density of 0.7 mA/cm² or more.

The charge current density found is compared to the value of 97.0% found for the conventional 1 M LiAsF₆ system in 1,3-dioxolane at a charge current density of 0.7 mA/cm² as determined in a 20/32 coin cell. In extensive research into gel-forming copolymers and terpolymers, aimed at the formation of a gel for immobilizing the electrolyte, it has surprisingly been found that not the gel formation itself yields an improvement of the Coulomb efficiency (actually a deterioration of the situation is involved, viz. a Coulomb efficiency of 95.0%) but the formation of a reaction product as a result of the coating or impregnation of a standard polyolefin separator with a polymer containing C—Cl groups. In case a terpolymer is used, this terpolymer, in addition to a chlorinated polymer, for instance of the chlorotrifluoroethylene type, preferably also contains fluorinated polymers, for instance of the vinilydene fluoride and hexafluoropropylene type. Surprisingly, it has been found that, in fact, the application of a terpolymer in the separator or on one side, located at the lithium anode electrode, has an unexpectedly favorable influence on the Coulomb efficiency through the possible formation of a mixed ionic conductive “glass”, probably consisting of LiCl and LiF. The presence of a copolymer with only fluorinated polymers leads to the formation of LiF, which actually leads to a deterioration of the Coulomb efficiency. This is precisely what renders the results for the mixed ionic conductor so surprising. In the standard Tadiran system, in which the separator is impregnated with a terpolymer or is coated with a terpolymer on the side located on the lithium anode side, measured in a 20/32 coin cell, the Coulomb efficiency for the lithium plating increases from 95% to 99.8% at a charge current density of 1.4 mA/cm². This means that the loss per cycle has strongly decreased, because now a loss of only 0.2% per cycle occurs instead of 5.0% per cycle. In addition to this improvement, another surprising improvement is involved. In the absence of the terpolymer, in the first charge/discharge cycles, a passivation of the lithium metal occurs which leads to Coulomb efficiencies which are considerably lower than 95.0%, which is disadvantageous for the total capacity of the cell. However, in the presence of the terpolymer a totally different behavior occurs. During the first cycles, the ratio of the discharge capacity and the charge capacity is higher than 100%, that is, the discharge capacity is higher than the charge capacity for the first cycles. This means that a totally different passivation behavior is involved. After formation of the passivation layer, a stabilization up to a value of 99.8% or more occurs. This development of the Coulomb efficiency is a striking difference with the standard Tadiran system in which no LiCl can be formed on the lithium surface because no chlorine containing compounds are present in the standard Tadiran electrolyte. Moreover, it appears that the influence of LiF is markedly different from that of LiCl because when a copolymer (fluorinated) is used, a deterioration instead of an improvement of the Coulomb efficiency occurs. That is why it is all the more surprising that the use of a chlorine containing terpolymer leads to an improvement of the Coulomb efficiency. This means that the lithium/electrolyte interface is stabilized to a large extent without too large a degree of passivation of the lithium interface occurring.

In addition to the terpolymer mentioned, it has been found that a polymer of a chlorinated monomer too, in particular vinyl chloride, leads to the same surprising results as were found with the terpolymer mentioned. However, the difference is that the terpolymer does yield: gel formation whereas the mono-polymer does not. A particular advantage of polyvinyl chloride (PVC) is that this polymer is inexpensive. The use of in situ formed LiCl as passivation of lithium metal is known for primary lithium batteries inter alia for the lithium thionyl chloride battery. However, the main distinction is that this is not a rechargeable battery system but a system where, again and again, the coating needs to be repaired. Further, another important distinction is that in the lithium thionyl chloride system, a large degree of passivation occurs, which is undesired in the present rechargeable lithium metal system described here. There is also a rechargeable lithium metal system wherein use is made of LiAlCl₄ as electrolyte. In this system, chlorine gas forms on the cathode (positive electrode) which is reduced to LiCl on the lithium. However, the use of LiAlCl₄ is not possible if carbon is present, for instance when carbon black is present as electronic conductor in the cathode. The formation of chlorine gas leads to a reaction with carbon black and has other drawbacks too. As a result, materials other than carbon black are necessary in the cathode, such as cobalt, which other materials are much more expensive. Furthermore, the LiAlCl₄ only acts in the presence of SO₂.

An important point of the present invention is that LiCl is formed in situ as a very thin coating on the lithium side and, surprisingly, this very formation of possibly both LiCl and LiF as mixed Li-ion conductor appears to have a very favorable influence on the lithium Coulomb efficiency. The formation of LiCl alone as a thin coating might be even more efficient but this is not possible in a system in which only an F-containing salt (LiAsF₆) and F-containing materials are present because then only LiF is formed as a reaction product with lithium and no Li—Cl can be formed.

In the case a terpolymer is used, three roles can be distinguished, which roles can be elucidated well with reference to VDF-HFD-CTFE:

i) VDF is the bulk of the system, behaving as the backbone and serving as the basis for the solubility of the terpolymer

ii) the addition of HFP reduces the crystallinity of the system. VDF and HFD together yield a good mechanical stability and a simple film formation. In addition, the combination of VDF and HFP with a liquid electrolyte yields a good gel formation.

iii) The addition of CTFE stabilizes the surface as a result of the formation of LiCl in combination with LiF on the lithium interface.

In addition to the improvement of the deposition behavior (higher Coulomb efficiency) and less loss during the first cycles, the use of terpolymers with a chlorine containing component such as chlorotrifluoroethylene CTFE leads to a process of gel formation resulting in immobilization of the liquid electrolyte. As a result, the safety of the system is strongly improved because no liquid electrolyte is present any longer. It is supposed that due to the presence of the chlorinated polymer a “self-repairing” solid electrolyte interface (Solid Electrolyte Interface, SEI) can be formed on the lithium anode. The chlorinated polymer is used here for stabilizing the interface, for improving the ion conductivity and for reducing the charge transfer resistance between the electrode and the electrolyte. As a result, an increased Coulomb efficiency and a longer cycling life are obtained. Moreover, the battery becomes safer.

Preferably, the electrolyte which is used in the battery according to the present invention comprises a saline solution in an organic medium. The electrolyte can comprise, for instance, one or more of the following salts: LiAsF₆, LiSbF₆, LiClO₄, Li-bis-oxalatoborate (Li—BOB), LiBF₄, Li—BETI (LiN(SO₂C₂F₅)₂, lithium trifluoromethane sulfonate (LiCF₃SO₃), and Li-TFSI (LiN(SO₂CF₃). A suitable organic medium is 1,3-dioxolane, but other solvents or combinations of solvents can be used as well.

According to a preferred embodiment, the electrolyte in the battery according to the invention comprises a Li-ion conductive medium on the basis of an inorganic electrolyte, preferably LiAlCl₄.

According to another preferred embodiment, the electrolyte in the battery according to the invention comprises a Li-ion conductive medium which comprises organic cations and organic or inorganic anions. Such a medium is also indicated as a ionic liquid. Selected suitable organic cations are, for instance, imidazolium, pyridinium, pyrrolidinium and mixtures thereof. Suitable anions are, for instance, hexafluorophosphate PF₆—, tetrafluoroborate BF₄—BETI—, and mixtures thereof

The advantages of the new system, wherein the existing Li-metal anode systems (such as the Li/LiAsF₆ in 1,3-dioxolane/Li_{0.33}MnO₂ system) are strongly improved by using chlorine and fluorine containing compounds by applying, in situ, a mixed LiCl—LiF ionic conductive layer (for instance by means of the use of a one-sidedly applied coating or impregnation with a chlorine containing and fluorine containing (ter)polymer of a suitable matrix, for instance on the basis of polyolefins), are: an improved Coulomb efficiency, a safer system as a result of gel formation (compared to liquid electrolyte) and the possibility for improving the mechanical properties.

According to a special embodiment, a cathode of the sulfur-type is used, preferably a cathode comprising elemental sulfur to which an electron conductor is added, for instance carbon black and a polymer which is conductive for Li-ions, for instance polyethylene oxide (PEO). The cathode according to this embodiment further comprises an electrolyte, which can be, for instance, an organic electrolyte having a composition of, for instance, 0.5 M LiTFSI (lithium(bis)trifluoromethylsulfonyl)imide)) in 3 M Li₂S₈ in tetraglyme. The electrolyte in the cathode according to this embodiment can also be LiSo₃CF₃ in Li₂S₈ (for instance 0.5 MLiSo₃CF₃) in, for instance, 3M Li₂S₈).

### EXAMPLES

A 20/32 coin cell was used as test platform for the lithium metal battery according to the invention. In the cell, there were a lithium metal anode (thin film lithium metal on Cu as carrier), an intercalation cathode (Li_{0.33}MnO₂, Super P Carbon Black and PVDF binder) and a separator. The separator was impregnated with polymer and then placed in an electrolyte solution (1M LiAsF₆ in 1,3-dioxolane stabilized with TBA). The pressure could be set with a spring and a spacer.

### Comparative Example

The separator used was a standard polypropylene membrane (Celgard® 2400). The battery was subjected to charge/discharge cycles with a charge current density of 1.4 mA/cm². A cycling efficiency of 92% was measured. The cycling life was determined at 10-15 cycles, after which a soft short circuit was observed caused by dendrite formation.

### Example 1

Comparative Example 1 was repeated, but now, the standard separator was impregnated with PVC. A cycling efficiency of 98.5% was measured.

### Example 2

Comparative Example 1 was repeated, but now, the standard separator was impregnated with VDF-HFP-CTFE. A cycling efficiency of 99.8% was measured. Due to the presence of chlorine on the lithium metal/electrolyte interface, the lithium is stabilized as a result of the formation of LiCl. The fluorine present causes gel formation so that a good ionic conductivity is obtained, thus increasing the safety of the system because the liquid electrolyte is immobilized.

1. A rechargeable lithium metal battery comprising an electrolyte characterized in that said battery contains a separator which separator comprises a chlorinated polymer.

2. A battery according to claim 1, wherein said separator also comprises a fluorinated polymer.

3. A battery according to claim 1, wherein said chlorinated polymers comprise monopolymers, copolymers and/or terpolymers.

4. A battery according to claim 1, wherein said polymers are the same polymer, preferably a terpolymer.

5. A battery according to claim 4, wherein the terpolymer is VDF-HFP-CTFE (vinilydene fluoride-hexafluoropropylene-chlorotrifluoroethylene).

6. A battery according to claim 1, comprising a cathode of the sulfur type, which comprises preferably elemental sulfur and further an electron conductor (preferably carbon black) and a lithium ion conductive polymer (preferably PEO).

7. A batter according to claim 1, wherein the amount of lithium metal is selected such that the battery, in discharged condition, contains no or no appreciable amount of metallic lithium.

8. A battery according to claim 1, wherein said chlorine and fluorine containing compounds have been applied as coating on at least one side of the separator such that a coated side adjoins the lithium metal; and/or wherein said separator has been impregnated with said chlorine and fluorine containing compounds.

9. A battery according to claim 8, wherein said separator comprises at last one polyolefin.

9. A battery according to claim 6, wherein cross-linked chlorine and fluorine containing polymers are present in the separator or as separator.

10. A battery according to claim 6, wherein cross-linked chlorine and fluorine containing polymers are present in the separator or as separator.

11. A battery according to claim 8, wherein electrochemical inert nanomaterials, preferably ceramic material such as SiO₂ and Al₂O₃ are present in the cross-linked polymer.

12. A battery according to claim 1, wherein said electrolyte comprises a saline solution in an organic medium.

13. A battery according to claim 1, wherein said electrolyte comprises one or more salts selected from the group consisting of LiAsF₆, LiSbF₆, LiCIO₄, Li-bis-oxalatoborate (Li—BOB), LiBF₄, Li—BETI ((LiN(SO₂C₂F₅)x), lithium trifluoromethane sulfonate (LiCF₃SO₃), and LiTFSI (LiN(SO₂CF₃); and an organic medium, preferably comprising 1,3-dioxolane.

14. A battery according to claim 1, wherein said electrolyte is a Li-ion conductive medium on the basis of an inorganic electrolyte, preferably LiAICI₄.

15. A battery according to claim 1, wherein said electrolyte is a Li-ion conductive medium comprising organic cations and organic or inorganic anions (ionic liquids).

16. A battery according to claim 13, wherein said organic cations are selected from imidazolium, pyridinium, pyrrolidinium and mixtures thereof.

17. A batter according to claim 13 wherein said anions are selected from hexafluorophosphate PF₆₋, tetrafluoroborate BF₄, BETI—, and mixtures thereof.

18. A method for manufacturing a lithium metal battery comprising a step in which a separator is impregnted or covered with a chlorinated polymer, and optionally with a fluorinated polymer.

19. The use of a combination of chlorine and fluorine containing compounds in batters with lithium metal anode.

20. A battery according to claim 2, wherein said chlorinated polymers comprise monopolymers, copolymers and/or terpolymers.
